(19) United States
(12) Patent Application Publication
(10) Pub. No.: US 2011/0286728 A1
(43) Pub. Date: Nov. 24, 2011

(54) HEATER AND ELECTRIC INSTANT WATER HEATER

(75) Inventor: Oscar Chow, Zhong Shan City (CN)

(73) Assignee: XIOTIN INDUSTRY LTD., Zhong Shan City (CN)

(21) Appl. No.: 12/871,352

(22) Filed: Aug. 30, 2010

(30) Foreign Application Priority Data
May 24, 2010 (CN) 201020202758.0

(51) Int. Cl. F16L 53/00

(52) U.S. Cl. 392/468

(57) ABSTRACT

The present invention provides a heater and an electric instant water heater with the heater. The electric instant water heater includes a water tank having an outlet, a heater communicated with the outlet of the water tank and a control circuit. The heater includes an electric heating pipe and a thermal conductor having a curved water channel. The electric heating pipe is embedded in the thermal conductor. The spiral electric heating pipe is embedded in the thermal conductor to thereby increase the heat transferring area, and the spiral water channel is formed in the thermal conductor. The inner wall of the metal pipe is provided with screw threads to increase the heated area and have a self-cleaning function. Thus, the cold water is instantly heated.

### TECHNICAL FIELD

The present invention relates to water heaters, and more particularly, to a heater and electric instant water heater.

### BACKGROUND

The conventional water heater generally uses storage water heaters. When using storage water heater, the water stored in the heater must firstly be heated to the desired temperature in order to obtain the required hot water. This results in energy waste. When the hot water stored in water tank of the heater is used up, if users want to continue to use hot water, the water need to be re-injected to the water tank to heat. It takes a longer period of time to heat water. Thus, the continuous supply of hot water can not be immediately obtained.

In addition, the conventional water heaters are used at different environmental temperature, the users will get hot water at different temperature. When the outside temperature is higher, the hot water obtained by users has corresponding higher temperature, and when the outside temperature is lower, the hot water obtained by users has corresponding lower temperature. Moreover, in the existing technology, because of defectiveness in a temperature control system, the accuracy of the temperature from hot water can not be guaranteed.

There is, therefore, a need for an electric instant water heater, which has a function of instantly heating water, and is safe to use.

### SUMMARY

A technical problem solved by the present invention is to provide a heater which allows to rapidly heat the cold water.

The above-mentioned technical problems can be solved through the following technical means: a heating device is provided. The heating device includes an electric heating pipe, a thermal conductor with a curved water channel. The electric heating pipe is embeded in the thermal conductor.

Preferably, the thermal conductor is made of aluminum or aluminum alloy, and the water channel is formed by a spiral metal pipe.

Preferably, the electric heating pipe and metal pipe are embedded in the thermal conductor via extrusion process.

Preferably, the electric heating pipe is spiral and disposed around an outside circumference of the metal pipe.

Preferably, the heater further includes a control circuit, and the thermal conductor is provided with a thermal resistor electrically coupled to the control circuit.

Preferably, a plurality of annular protrusions extends outwardly from an outside wall of the thermal conductor corresponding to the electric heating pipe.

Preferably, the inner diameter of the metal pipe is in a range from 1 mm to 4 mm, the outside diameter of the electric heating pipe is in a range from 5 mm to 10 mm, and the power of the electric heating pipe is between 1000 W and 2300 W.

Preferably, the inner wall of metal pipe is provided with screw thread.

Another technical problem solved by the present invention is to provide an electric instant water heater with the above-mentioned heater.

The above-mentioned technical problem can be solved through the following technical means: An electric instant water heater includes an water tank having an outlet and a heater communicated with the outlet of the water tank. The heater includes an electric heating pipe and a thermal conductor having a curved water channel, wherein the electric heating pipe is embedded in the thermal conductor.

Preferably, a water pump is disposed between the water tank and the heater.

The spiral electric heating pipe is embedded in the metal thermal conductor to thereby increase the heat transferring area, and the spiral water channel is formed in the thermal conductor. The inner wall of the metal pipe is provided with screw threads to increase the heated area and have a self-cleaning function. Thus, the cold water is instantly heated.

Other objects, advantages and novel features of the present invention will become more apparent from the following detailed description when taken in conjunction with the accompanying drawings, in which:

### BRIEF DESCRIPTION OF THE DRAWINGS

FIG. 1 is a sectional view of an electric instant water heater in accordance with an embodiment of the present invention, and the electric instant water heater includes a heater therein;

FIG. 2 is a sectional view of the heater in accordance with the embodiment of the present invention; and

FIG. 3 is an exploded view of the heater.

### DETAILED DESCRIPTION OF THE PREFERRED EMBODIMENTS

Objects, advantages and embodiments of the present invention will be explained below in detail with reference to the accompanying drawings. However, it is to be appreciated that the following description of the embodiment(s) is merely exemplary in nature and is no way intended to limit the invention, its application, or uses.

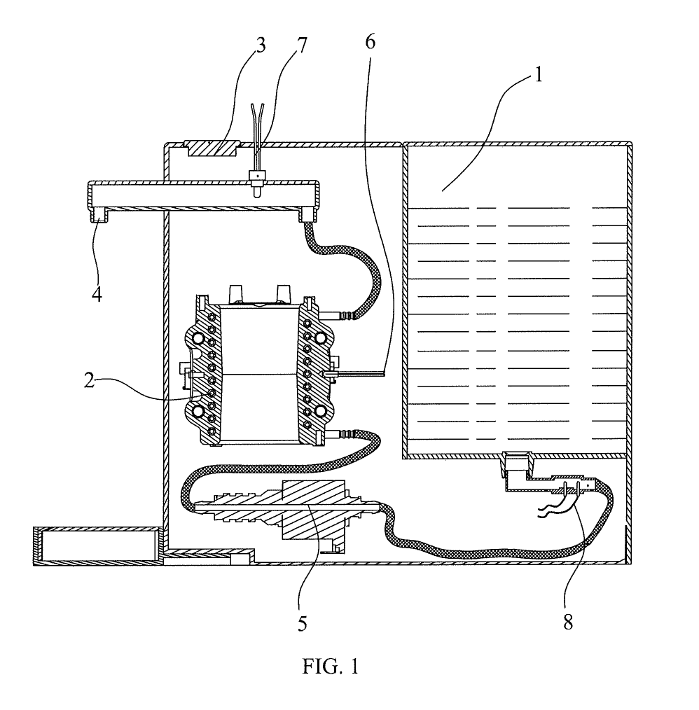

Referring to FIG. 1, the electric instant water heater includes a water tank 1, a heater 2 communicated with an outlet of the water tank 1, and a control circuit. In addition, the electric instant water heater further includes a pressing button 3, an outlet spout 4 communicated with an outlet of the heater 2, and so on.

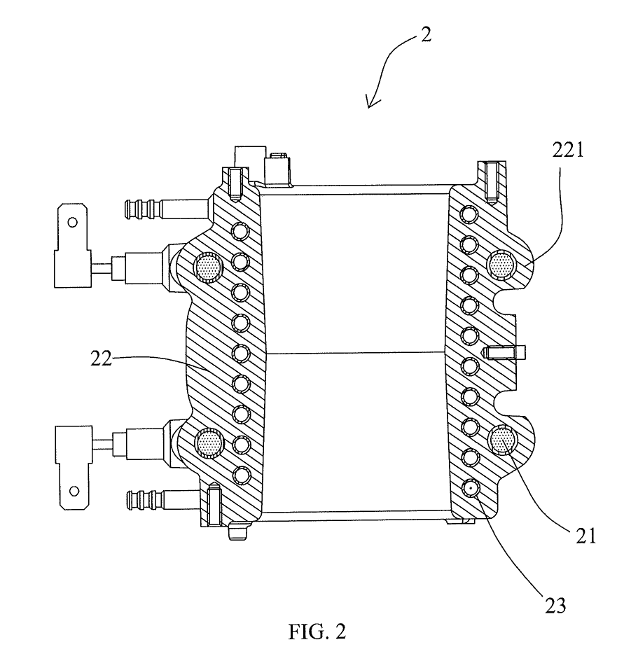

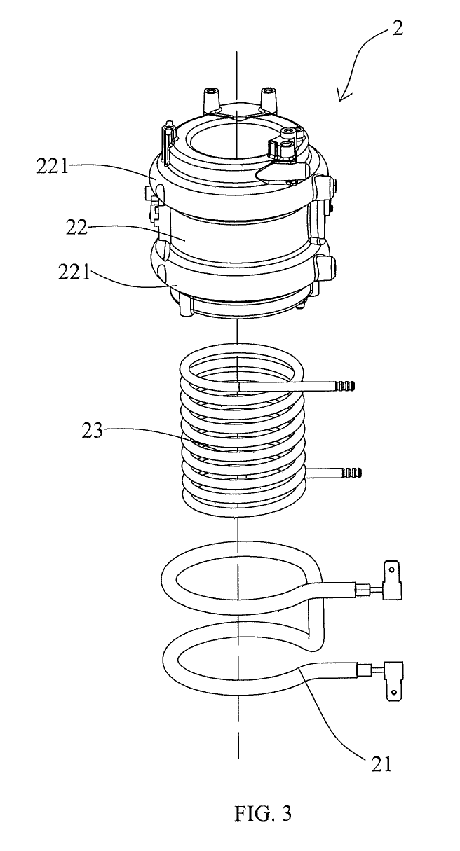

Referring to FIGS. 2 and 3, a heater 2 includes an electric heating pipe 21 and a metal thermal conductor 22 with a curved water channel 21. The electric heating pipe 21 is embedded in the metal thermal conductor 22. In the embodiment, the metal thermal conductor 22 is made of aluminum or aluminum alloy. The water channel is formed by a spiral metal pipe 23. The electric heating pipe 21 and metal pipe 23 are embedded in the metal thermal conductor 22 via extrusion process. Obviously, the metal thermal conductor 22 may be made of other metal or metal alloy which has a good thermal conductivity.

In order to make the cold water in the metal pipe 23 to be more uniformly heated, the electric heating pipe 21 is spiral and disposed around an outside circumference of the metal pipe 23.

At least one annular protrusions 221 extends outwardly from an outside wall of the metal thermal conductor 22 corresponding to the electric heating pipe 21 so that the heat generated by the electric heating pipe 21 is easily transferred to the metal pipe 23.

In addition, the inner wall of metal pipe 23 is provided with screw thread. The screw thread is configured so that not only the heat transferring area can be effectively increased, thereby to improve the heat exchange rate, but also the vortex and stir effect can be produced when the cold water flowing through the metal pipe 23 is driven under the action of hydraulic pressure. Thus, the driving force of water may be increased to prevent or eliminate generation and deposition of scale and play a self-cleaning function for the inner wall of the metal pipe 23.

More specifically, a water pump 5 may be disposed between the water tank 1 and heater 2. The inner diameter of the metal pipe 23 is in a range from 1 mm to 4 mm, the outside diameter of the electric heating pipe 21 is in a range from 5 mm to 10 mm, and the power of the electric heating pipe 21 is between 1000 W and 2300 W. These parameters are set so that the cold water from the water tank 1 is heated rapidly to above 95 degrees, and then flows out from the outlet spout 4 to achieve a continuous outflow of the water.

In this embodiment, the electric instant water heater further includes a control circuit (not shown). The metal thermal conductor 22 is provided with a thermal resistor 6 electrically coupled to the control circuit. Moreover, in order to avoid users obtaining the water with different temperature in different environmental temperatures, the electric instant water heater further includes another thermal resistor 7 which is able to be solely operated. The thermal resistor 7 is used for detecting the temperature of the hot water from the outlet. The water pump 5 is controlled by controlled silicon and thermal resistor 7 so that flow rate of the water pump 5 is controlled. Thus, the temperature of the hot water from the outlet will not be affected by the change of environmental temperature.

In addition, a protection device 8 is provided in an inlet of the water pump 5. The protection device 8 has a lead and two metallic body electrically coupled to the lead and is used for detecting the resistance change of the water within an inlet pipe of the water pump, when the water tank is drained, the change signal of the resistance value is transmitted to the control circuit, and then the control circuit sends a control signal to switch off the power supply of the heaters 2 and pump 5. Accordingly, the heater 2 will not be overheated to be damaged, and the pump 5 will not be damaged.

In summary, the spiral electric heating pipe 21 is embedded in the metal thermal conductor 22 to thereby increase the heat transferring area, and the spiral water channel is formed in the metal thermal conductor 22. The inner wall of the metal pipe 23 is provided with screw threads to increase the heated area and have a self-cleaning function. Thus, the cold water is instantly heated.

The present invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A heater comprising:
an electric heating pipe; and
a thermal conductor having a curved water channel, wherein the electric heating pipe is embedded in the thermal conductor.

2. The heater as claimed in claim 1, wherein the thermal conductor is made of aluminum or aluminum alloy, and the water channel is formed by a spiral metal pipe.

3. The heater as claimed in claim 2, wherein the electric heating pipe and metal pipe are embedded in the thermal conductor via extrusion process.

4. The heater as claimed in claim 3, wherein the electric heating pipe is spiral and disposed around an outside circumference of the metal pipe.

5. The heater as claimed in claim 1, further comprising a control circuit, and the thermal conductor is provided with a thermal resistor electrically coupled to the control circuit.

6. The heater as claimed in claim 1, wherein a plurality of annular protrusions extends outwardly from an outside wall of the thermal conductor corresponding to the electric heating pipe.

7. The heater as claimed in claim 3, wherein the inner diameter of the metal pipe is in a range from 1 mm to 4 mm, the outside diameter of the electric heating pipe is in a range from 5 mm to 10 mm, and the power of the electric heating pipe is between 1000 W and 2300 W.

8. The heater as claimed in claim 2, wherein the inner wall of metal pipe is provided with screw thread.

9. An electric instant water heater comprising:
an water tank having an outlet; and
a heater communicated with the outlet of the water tank;
the heater comprising:
an electric heating pipe; and
a thermal conductor having a curved water channel, wherein the electric heating pipe is embedded in the thermal conductor.

10. The electric instant water heater as claimed in claim 9, wherein the thermal conductor is made of aluminum or aluminum alloy, and the water channel is formed by a spiral metal pipe.

11. The electric instant water heater as claimed in claim 10, wherein the electric heating pipe and metal pipe are embedded in the thermal conductor via extrusion process.

12. The electric instant water heater as claimed in claim 11, wherein the electric heating pipe is spiral and disposed around an outside circumference of the metal pipe.

13. The electric instant water heater as claimed in claim 9, further comprising a control circuit, and the thermal conductor is provided with a thermal resistor electrically coupled to the control circuit.

14. The electric instant water heater as claimed in claim 9, wherein a plurality of annular protrusions extends outwardly from an outside wall of the thermal conductor corresponding to the electric heating pipe.

15. The electric instant water heater as claimed in claim 11, wherein the inner diameter of the metal pipe is in a range from 1 mm to 4 mm, the outside diameter of the electric heating pipe is in a range from 5 mm to 10 mm, and the power of the electric heating pipe is between 1000 W and 2300 W.

16. The electric instant water heater as claimed in claim 10, wherein the inner wall of metal pipe is provided with screw thread.

17. The electric instant water heater as claimed in claim 9, wherein a water pump is disposed between the water tank and the heater.
